(19) United States
(12) Patent Application Publication
(10) Pub. No.: US 2010/0096371 A1
(43) Pub. Date: Apr. 22, 2010

(54) SYSTEM AND METHOD FOR SURFACE CLEANING USING A LASER INDUCED SHOCK WAVE ARRAY

(76) Inventors: Robert R. Bousquet, Frederick, MD (US); Chad Y. Sheng, Columbia, MD (US); Michael P. Lynch, Centreville, MD (US); Robert A. Rashford, Gaithersburg, MD (US)

Correspondence Address: WELSH & FLAXMAN LLC, 2000 DUKE STREET, SUITE 100, ALEXANDRIA, VA, 22314, US

(21) Appl. No.: 12/582,226

(22) Filed: Oct. 20, 2009

Related U.S. Application Data
(60) Provisional application No. 61/106,710, filed on Oct. 20, 2008.

(51) Int. Cl. B23K 26/36

(52) U.S. Cl. 219/121.68

(57) ABSTRACT

A contamination removal system for continuous cleaning of contamination from an exposed contaminated surface of a substrate by creating and moving a laser induced shock wave array across the contaminated surface includes a laser beam source and laser beam delivery assembly receiving a beam generated at the laser beam source and directing the beam for the generation of a shock wave array. The beam delivery assembly includes mirrors and beam splitters which split the laser beam into many laser beams. The contamination removal system also includes a control assembly composed of an analog or digital controller and a motion controller linked to the operating components of the present system and ensuring proper operation thereof. A substrate motion control/holder assembly supports the substrate adjacent the beam delivery assembly. The substrate motion control/holder assembly is linked to the motion controller of the control assembly for complete and comprehensive operation, wherein the substrate motion control/holder assembly continually translates the substrate in a highly controlled manner to ensure the creation of the shock wave array along the exposed contaminated surface of the substrate in a systematic manner such that the contaminates are moved off of the exposed contaminated surface of the substrate resulting in a clean surface for subsequent use and fabrication.

### CROSS REFERENCE TO RELATED APPLICATIONS

This application claims the benefit of U.S. Provisional Patent Application Ser. No. 61/106,710, filed Oct. 20, 2008, entitled “SYSTEM AND METHOD FOR SURFACE CLEANING USING A LASER INDUCED SHOCKWAVE ARRAY”.

### BACKGROUND OF THE INVENTION

1. Field of the Invention

The invention relates to a commercial system and method for cleaning contamination from a surface. More particularly, the invention relates to a system and method for cleaning contamination from a surface by moving a laser induced shock wave array across the contaminated surface. As a result, the present system and method are adapted for use in a commercial setting in the continuous cleaning of substrates being moved through a processing plant, and allow for the treatment of flexible surfaces shaped by rollers during a manufacturing process.

2. Description of the Related Art

The need for clean environments and clean surfaces has become highly important with the development of high technology processes and products. The present invention provides a system and method for the continuous cleaning of contaminated surfaces, whether the surfaces are rigid or flexible, for subsequent processing.

### SUMMARY OF THE INVENTION

It is, therefore, an object of the present invention to provide a contamination removal system for continuous cleaning of contamination from an exposed contaminated surface of a substrate by creating and moving a laser induced shock wave array across the contaminated surface. The contamination removal system includes a laser beam source and laser beam delivery assembly receiving a beam generated at the laser beam source and directing the beam for the generation of a shock wave array. The beam delivery assembly includes mirrors and beam splitters which split the laser beam into many laser beams. The contamination removal system also includes a control assembly composed of an analog or digital controller and a motion controller linked to the operating components of the present system and ensuring proper operation thereof. A substrate motion control/holder assembly supports the substrate adjacent the beam delivery assembly. The substrate motion control/holder assembly is linked to the motion controller of the control assembly for complete and comprehensive operation, wherein the substrate motion control/holder assembly continually translates the substrate in a highly controlled manner to ensure the creation of the shock wave array along the exposed contaminated surface of the substrate in a systematic manner such that the contaminates are moved off of the exposed contaminated surface of the substrate resulting in a clean surface for subsequent use and fabrication.

It is also an object of the present invention to provide a contamination removal system wherein the laser beams are oriented in a line running transverse to the direction of relative movement between the line of laser beams and the substrate.

It is another object of the present invention to provide a contamination removal system wherein the laser beam source is a Nd:YAG laser producing laser light with a pulse width in the nanosecond to subnanosecond range.

It is a further object of the present invention to provide a contamination and removal system wherein the substrate motion control/holder assembly is a translational stage used to move the substrate past the shock wave array.

It is also an object of the present invention to provide a contamination removal system wherein the substrate motion control/holder assembly is a rotational stage.

It is another object of the present invention to provide a contamination removal system wherein the rotational stage includes at least one roller allowing the substrate to pass thereover.

It is a further object of the present invention to provide a contamination and removal system wherein the laser beam source and beam delivery assembly sit adjacent an apex of the single roller and directs the laser beams tangentially to the apex of the exposed surface of the flexible substrate as it passes over the single roller to create a laser induced shock wave array.

It is also an object of the present invention to provide a contamination removal system wherein the at least one roller is made of stainless steel.

It is another object of the present invention to provide a contamination removal system wherein the rotational stage includes a first roller and a second roller.

It is a further object of the present invention to provide a contamination and removal system wherein the first roller and the second roller are oriented such that their respective longitudinal axes are parallel and lie in the same plane.

It is also an object of the present invention to provide a contamination removal system wherein the first roller and the second roller are spaced sufficiently close such that a single line of lower powered laser beams may be applied between the first roller and the second roller creating a shock wave array simultaneously cleaning both a first exposed contaminated surface of the flexible substrate passing over the first roller, and a second exposed contaminated surface of the flexible substrate passing over the second roller.

It is another object of the present invention to provide a contamination removal system wherein the laser beam source creates a laser beam that is directed toward the beam delivery assembly.

It is another object of the present invention to provide a contamination removal system wherein the lower powered laser beams are oriented in a line running transverse to a direction of relative movement between the line of the laser beams and the substrate.

It is a further object of the present invention to provide a contamination and removal system wherein the laser beams are focused and directed tangentially above the exposed contaminated surface of the substrate to be cleaned, creating a shock wave array positioned directly above that portion of the exposed contaminated surface cleaned by the creation of the shock wave array.

It is also an object of the present invention to provide a contamination removal system including a carrier gas to facilitate particulate removal on the exposed contaminated surface of the substrate and the prevention of recontamination of the exposed contaminated surface.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a top schematic view of a contamination removal system in accordance with the present invention.

FIG. 2 is a side schematic view of the system disclosed with reference to FIG. 1.

FIG. 3 is a schematic view of the present system.

FIG. 4 is a side schematic view of an alternate embodiment of the present system employing a single roller for use with a flexible substrate.

FIGS. 5A and 5B are side schematic views of an alternate embodiment of the present system employing two rollers for use with a flexible substrate(s).

FIGS. 6 and 7 are side schematic views of yet other embodiments of the present system intended for use with flexible substrates and including a duct and vent.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

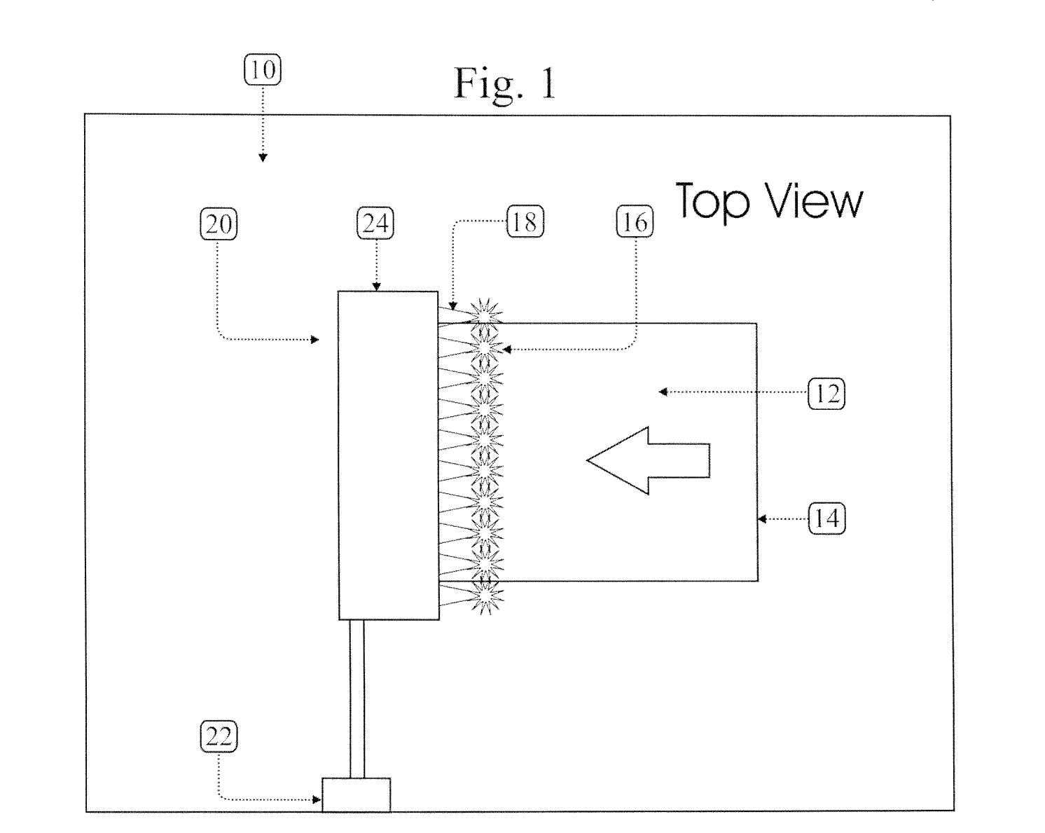

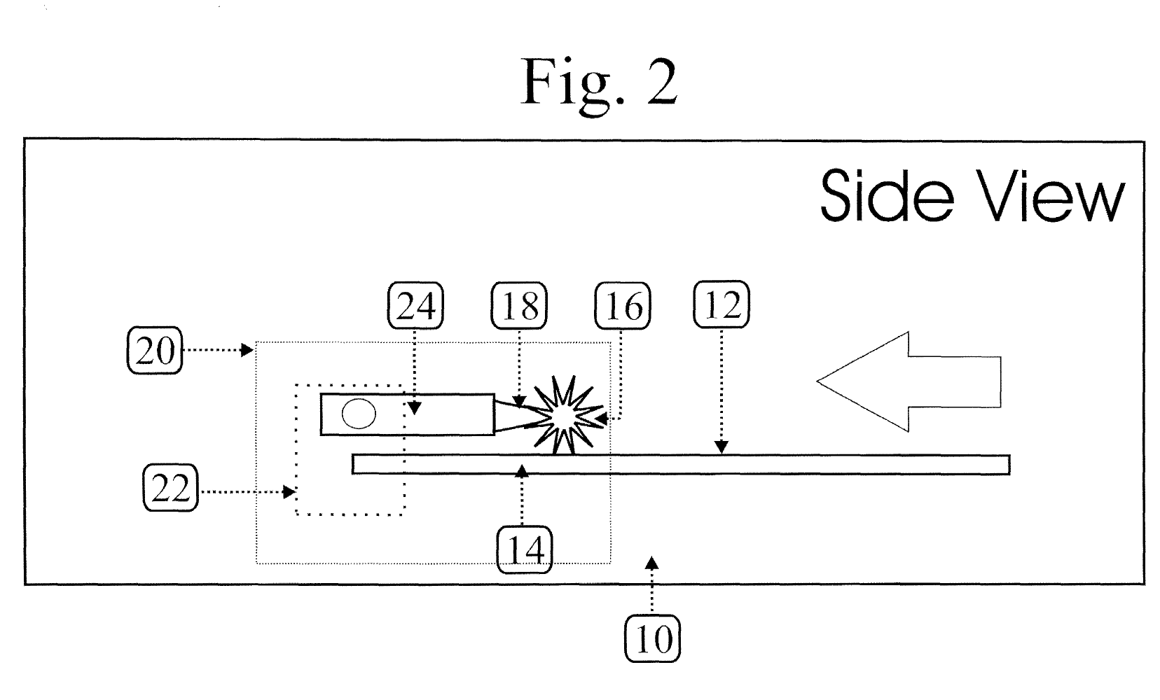

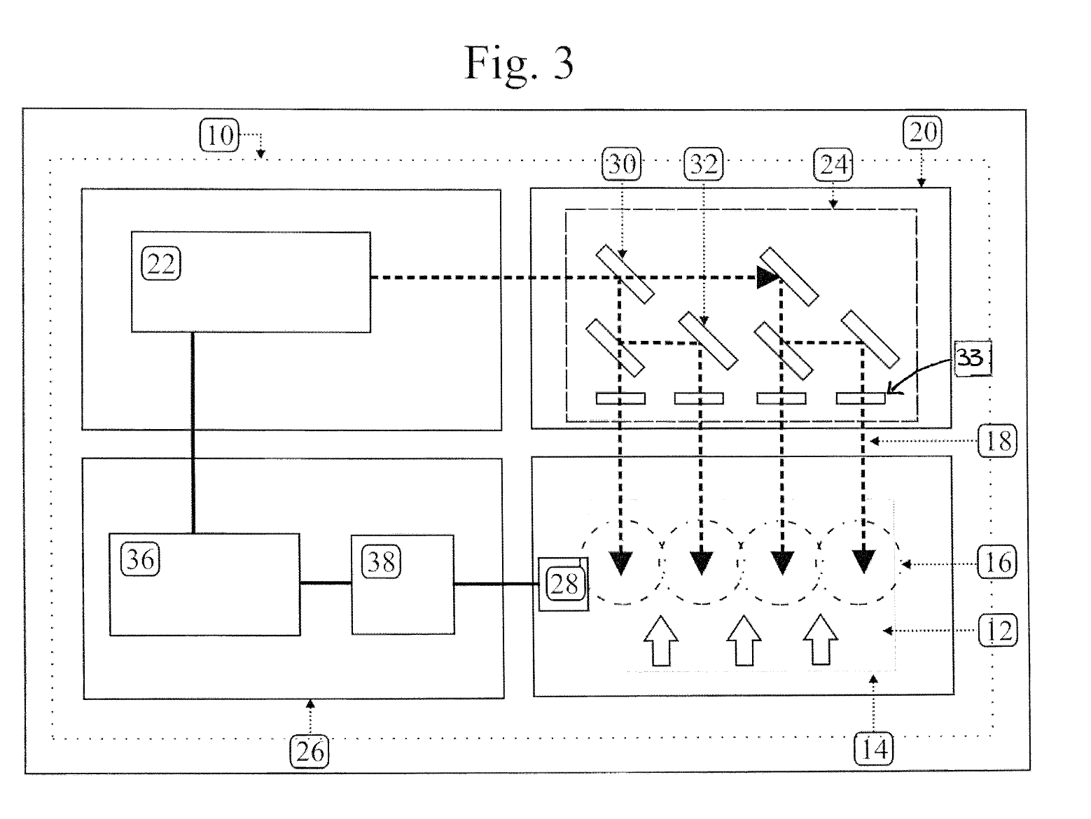

In accordance with the present invention, and with reference to the embodiments disclosed in FIGS. 1 to 5B, a contamination removal system 10, 110, 110′ and method are disclosed for continuous cleaning of contamination from an exposed contaminated surface 12, 112, 112′ of a substrate 14, 114, 114′ by creating and moving a laser induced shock wave array 16, 116 across the contaminated surface 12, 112, 112′. The shock waves used to clean the contaminated surface 12, 112, 112′ are generated by the laser induced break down of a gas formed by a focused, pulsed laser beam. As the following disclosure will make clear, the present contamination removal system 10, 110, 110′ is particularly adapted for use in a commercial setting in the continuous cleaning of substrates being moved through a processing plant, and allows for the treatment of rigid flat surfaces or flexible curved surfaces as they pass over rollers during a manufacturing process.

Briefly, the contamination removal system 10, 110, 110′ includes a laser beam source 22, 122 (or pulsed laser assembly) and a beam delivery assembly 24, 124 (or optical system) receiving a laser beam generated at the laser beam source 22, 122 and directing the laser beam for the generation of shock wave array 16, 116. The beam delivery assembly 24,124 includes mirrors 30, 130 and beam splitters 32, 132 which split the laser beam generated by the laser beam source 22, 122 into many lower powered laser beams 18, 118. A control assembly 26, 126 composed of a computer (or analog or digital controller) 36, 136 and a motion controller (or motion system) 38, 138 are linked to the operating components of the present contamination removal system 10, 110, 110′ and ensure proper operation thereof. A substrate motion control/holder assembly (or motion stage) 28, 128, 128′ supports the substrate 14, 114, 114′ adjacent to the beam delivery assembly 24, 124. The substrate motion control/holder assembly (or motion stage) 28, 128, 128′ is linked to the motion controller 38, 138 of the control assembly 26, 126 for complete and comprehensive operation thereof. The substrate motion control/holder assembly 28 continually translates the substrate 14, 114, 114′ in a highly controlled manner to ensure the creation of shock waves 16, 116 along the exposed surface of the substrate 14, 114, 114′ in a systematic manner such that the contaminates are moved off of the exposed surface of the substrate 14, 114, 114′ resulting in a clean surface for subsequent use and fabrication.

As those skilled in the art will appreciate, the resulting shock waves created by the laser induced breakdown (LIB) of a gas is a well established phenomenon. This process is discussed by Lee, J. M. and Watkins, K. G., “Removal of small particles on silicon wafer by laser-induced airborne plasma shock waves”, J. Appl. Phys. v 89, p 6496 (2001), Bach, G. G. and Lee, J. H. S., “An analytical technique for laser-driven shock waves”, Acta Astronautica, v 1, p 761, (1974), Harith, M. A., Palleschi, V., Salvetti, A. Singh, D. P., Tropiano, G. and Vaselli, M., “Experimental studies on shock wave propagation in laser produced plasmas using double wavelength holography” Opt. Commun., v 71, n1, 2, p 76 (1989), and Kim, D., Bukuk, O., Jang, D., Lee, J., Lee, J., “Experimental and theoretical analysis of the laser shock cleaning process for nanoscale particle removed”, Applied Surface Science, 253 (8322) 2007-8327, all of which are incorporated herein by reference. Briefly, the necessary conditions for laser induced breakdown include a beam of focused, pulsed light of sufficient energy to ionize the air and thereby cause laser induced breakdown. Factors of the laser which affect the laser ionization of the gas are the wavelength of the laser radiation, the intensity of the laser radiation, and the pulse width of the laser radiation. The plasma resulting from the laser induced breakdown of the gas rapidly expands via the Reverse-Bremsstrahlung effect (or the acceleration of electrons due to the absorption of the laser radiation). In accordance with a preferred embodiment of the present invention, and as discussed below in greater detail, a Nd:YAG laser in air is used to create the shock waves, however, it is contemplated alternative schemes may be employed without departing from the spirit of the present invention. The gas that is used to create the LIB may either be the air or may be a gas that can facilitate the laser induced breakdown and propagation of the shock wave. The laser induced breakdown may be created directly above the surface or may be created in a set of shock wave shaping surfaces that can direct the subsequent shock wave over the surface to be cleaned. As those skilled in the art will certainly appreciate, the laser induced breakdown is not limited to a particular gas.

In accordance with preferred embodiments, and as will be discussed below in greater detail, a series of optical manipulators are used to act upon a laser beam to create a line of lower powered laser beams 18, 118 that interact with gases to create a linear array (that is, a line) of shock waves 16, 116 above a contaminated surface 12, 112, 112′ of a substrate 14, 114, 114′ and across the surface perpendicular to the direction of translation of the laser induced shock wave array 16, 116 or the substrate 14, 114, 114′. The combined effect of the shock wave array 16, 116 is to push the particles in one direction across the contaminated surface 12, 112, 112′ thereby leaving a clean surface.

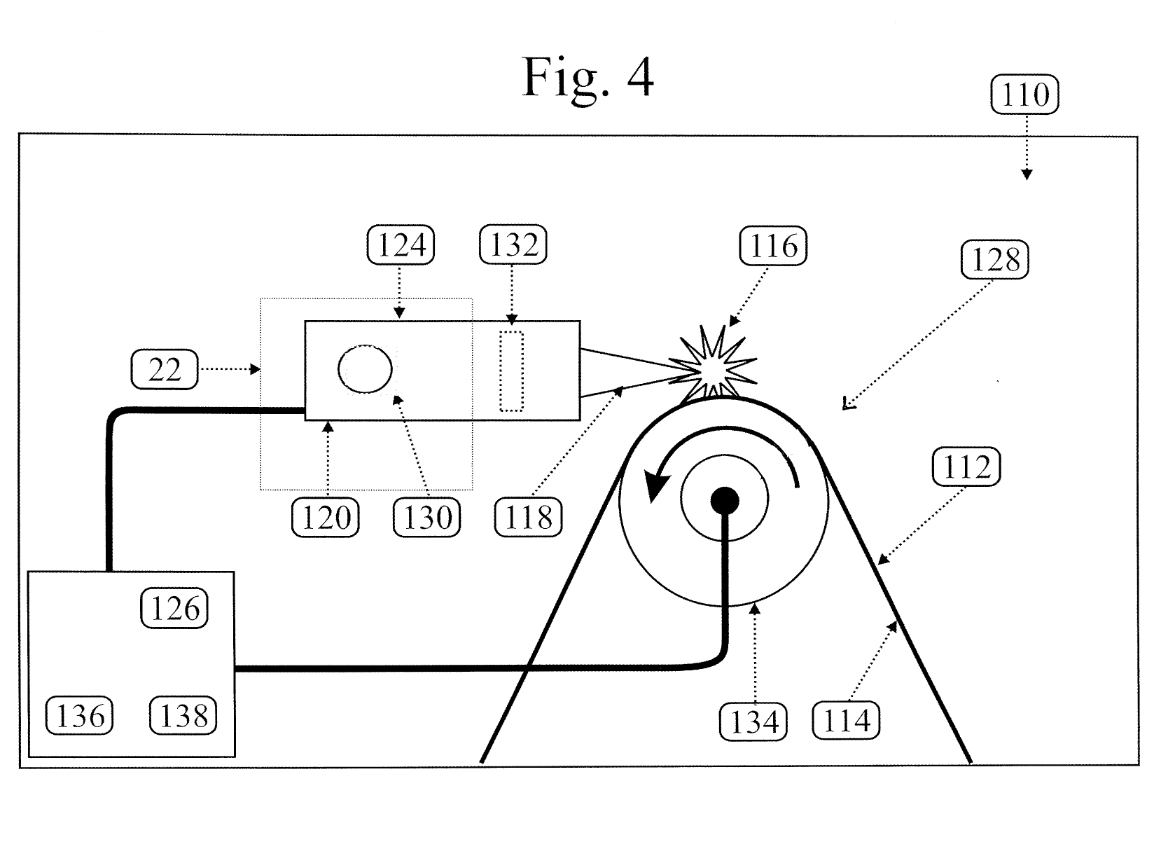

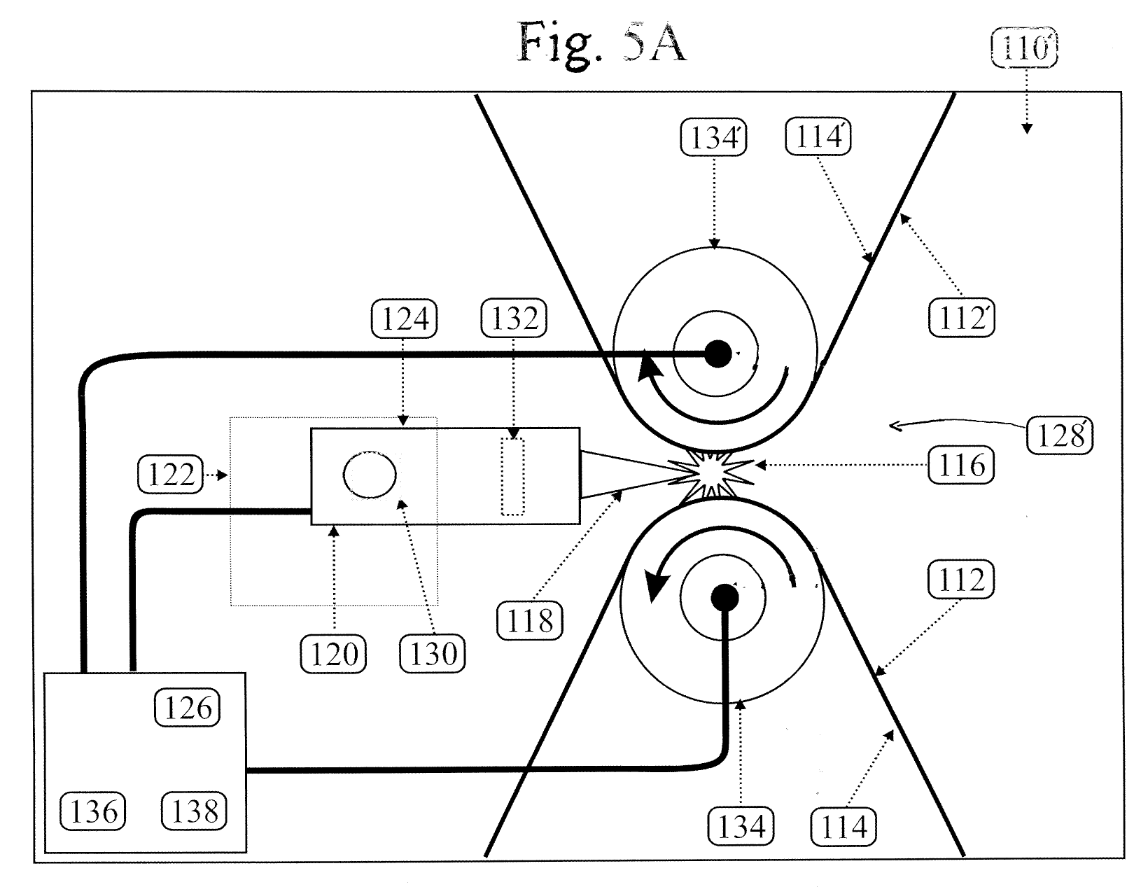

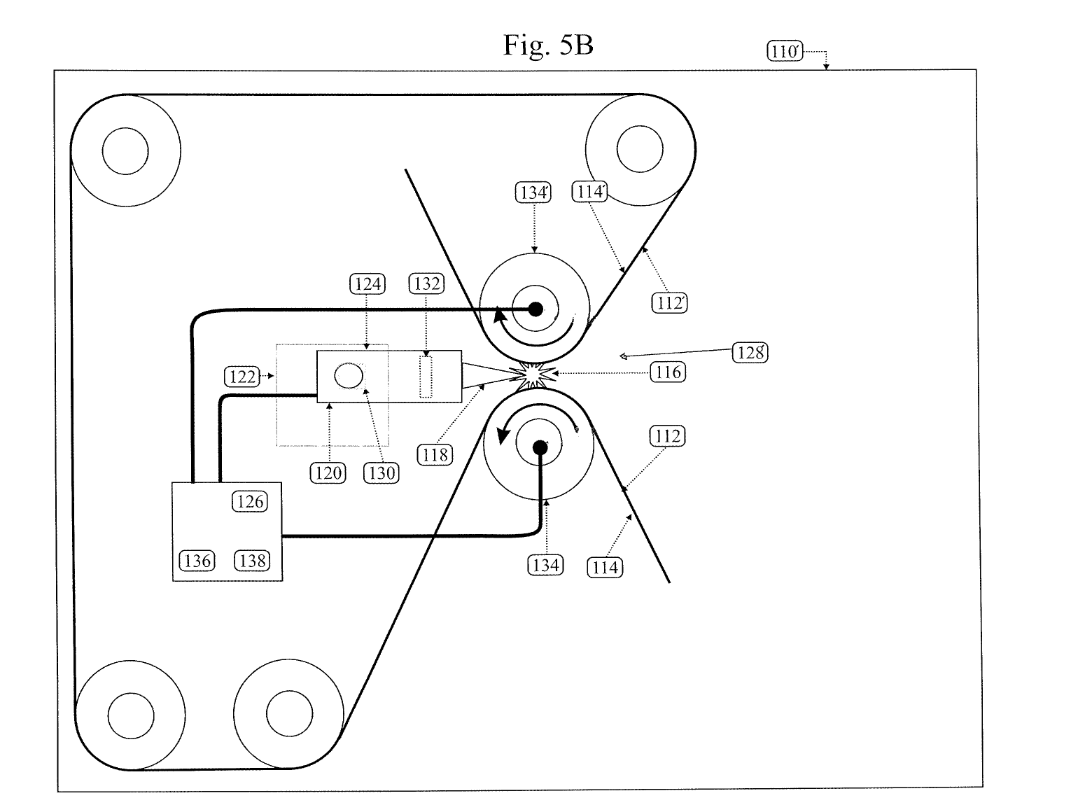

It is contemplated the present method may be used in cleaning either rigid substrates 14 (as disclosed with reference to FIGS. 1 to 3) or flexible substrates 114, 114′ (as disclosed with reference to FIGS. 4, 5A and 5B). The present invention may be used on both rigid and flexible substrates of any material(s) composition. The present invention is intended for use on both patterned and unpatterned (bare) surfaces. While the present invention does not target a specific contaminant, it is intended primarily for the removal of particulates (of any material) in the micron to sub-micron range and any intermediate materials that bind the particles to the surface (i.e. liquids) of the substrates. For example, but not limited to, the present invention may be applied in the removal of contaminants from rigid and flexible displays and optical apparatuses.

In accordance with a preferred implementation of the present invention, there are several contaminants that one can encounter in a cleanroom environment. One type is “fall out” which in lay terms is the dust in the ambient environment. Another type of contaminant would be from humans, such as hair follicles, skin flakes, etc. Other types of contaminants would be from materials of construction (fastening of metal may produce metallic particulates) and substrates. A specific example of shock wave cleaning could be fallout (room dust) of micron and submicron sized particulates on the surface of a flexible substrate. An example with a specific substrate would be fallout on a PEN (polyethylene naphthalate) substrate. The fallout is then cleaned off of the substrate with the present shock wave method and system.

More particularly, and with reference to FIGS. 1, 2 and 3, a preferred embodiment of a system 10 for use in the present method for the treatment of a rigid substrate 14 is disclosed. In accordance with this embodiment, a substrate 14 with an exposed contaminated surface 12 is treated. The exposed surface 12 is treated through the creation and application of a laser induced shock wave array 16 which cleans the exposed contaminated surface 12. The exposed contaminated surface 12 is first oriented for the application of a plurality of lower powered laser beams 18 which act to cause the breakdown of a gas adjacent to, and along, the exposed contaminated surface 12 of the substrate 14. The laser induced breakdown of the gas creates a shock wave array 16 in the vicinity of the exposed contaminated surface 12. The shock wave array 16 causes movement of the contaminating particles across the surface 12 so as to clean the surface 12. The lower powered laser beams 18 and the substrate 14 are continually moved relative to each other resulting in the creation of shock wave arrays 16 along the entire surface 12 of the substrate 14 until a completely clean exposed surface 12 is achieved.

In accordance with the embodiment referenced in FIGS. 1, 2 and 3, the laser assembly 20 employed in creating the laser induced shock wave array 16 includes a laser beam source (or pulsed laser assembly) 22, a beam delivery assembly (or optical system) 24, and a control assembly 26 composed of a computer (or analog or digital controller) 36 and a motion controller (or motion system) 38. The system also includes a substrate motion control/holder assembly (or motion stage) 28 which is linked to the control assembly 26 for complete and comprehensive operation of the present system 10.

Where the present invention is implemented and incorporated into an apparatus that already provides for substrate motion, the motion controller described herein may be omitted and the structure of the apparatus into which the present invention is incorporated may be employed. Similarly, where the present invention is integrated into an apparatus that will provide a timing pulse to the laser dependent on the processing speed of the laser, the motion controller and computer may be omitted. More particularly, and in accordance with such an embodiment, the motion of the substrate could also be passive in the sense that a flexible substrate is being pulled through the present system. This would then only require a timing pulse sent to the laser to clean at a speed dependent on the substrate motion which would be determined by the feed mechanism that supplies the substrate. In other words, this could be integrated into a larger system that would provide a timing pulse to fire the laser and would control the speed of the laser.

In accordance with a preferred embodiment, the laser beam source 22 is a Nd:YAG laser that is used to produce the laser light with a pulse width in the nanosecond to subnanosecond range. While a Nd:YAG laser is disclosed in accordance with a preferred embodiment of the present, it is contemplated other lasers could be utilized without departing from the spirit of the present invention. The characteristics of the laser pulse are preferably constant, however, it is contemplated other laser characteristics may be employed within the spirit of the present invention. The computer 36 is preferably a standard PC computer with software to control the motion of the substrate and the pulse of the laser. It is, however, contemplated users of the present invention may wish to control the rate at which the substrate moves or the laser fires (up to its maximum repetition rate) and this might make the computer unnecessary. The substrate motion control/holder assembly 28, 128,128′ is preferably either a translational stage (that is, a linear stage moving along two dimensions within a single plane as shown with reference to the embodiment of FIGS. 1, 2 and 3) or rotational stage (for example, rollers allowing the substrate to pass thereover as shown with reference to the embodiment shown with reference to FIGS. 4, 5A, 5B, 6 and 7) used to move the substrate past the shock wave array 16, 116. This again may be unnecessary if the concepts underlying the present invention are incorporated into another system which already controls the substrate speed.

In accordance with this embodiment, the process of generating the shock wave array 16 begins at the laser beam source 22. The laser beam source 22 creates a laser beam that is directed toward the beam delivery assembly 24. The beam delivery assembly 24 employs a series of mirrors 30 and beam splitters 32 to split the laser beam into many lower powered laser beams 18 and lenses 33 that focus these beams 18 at the point of cleaning. The lower powered laser beams 18 are preferably oriented in a line running transverse to the direction of relative movement between the line of lower powered laser beams 18 and the substrate 14 (which is moved under the control of the substrate motion control/holder assembly 28). In this way, the lower powered laser beams 18 may be moved relative to the substrate 14 in a manner pushing the particles off of the far end of the substrate 14. The lower powered laser beams 18 are focused and directed tangentially above the exposed surface of the substrate 14 to be cleaned, creating a shock wave array 16 positioned directly above that portion of the exposed surface 12 cleaned by the creation of the shock wave array 16.

In accordance with a preferred embodiment, the substrate 14 is continually translated by the substrate motion control/holder assembly 26 in a highly controlled manner to ensure the creation of shock waves 16 along the exposed surface 12 in a systematic manner such that the contaminates are moved off of the exposed surface 12 of the substrate 14 resulting in a clean surface 12 for subsequent use and fabrication. The preferred speed of translation will vary according to the laser in use (energy, repetition rate of pulses, etc.) The motion of the substrate 14 does not need to be fast in regards to the process of the contaminant removal since only the shock wave array 16 participates in removing the contaminants. The process employed through the utilization of the laser induced shock wave array in accordance with this embodiment, that is, the creation of the lower powered laser beams 18 and the movement of the substrate 14 is controlled by the control assembly 26. While the substrate is moved in accordance with a preferred embodiment disclosed herein, it is contemplated the laser assembly might be moved while the substrate remains stationary.

As discussed above, the present method may be employed in conjunction with a flexible substrate(s) 114, 114′ as well as a rigid substrate 14. With reference to FIGS. 4, 5A and 5B, alternate embodiments are disclosed for use of the present method in conjunction with a flexible substrate 114, 114′. Briefly, and in accordance with preferred embodiments for the cleaning of a flexible substrate 114, 114′, cleaning of an exposed surface(s) 112, 112′ of a flexible substrate(s) 114, 114′ is accomplished by translating the surface(s) 112, 112′ beneath the shock wave array 116 via a roller(s) 134, 134′. As will be appreciate based upon the following disclosure, the curved profile of the surface(s) 112, 112′ of the flexible substrate(s) 114, 114′ as it passes over the roller(s) 134, 134′ provides an additional advantage since the resultant adhesion force of the particulate contaminant follows the surface normal along the curved surface(s) 112, 112′, while the shock wave array 116 applies a force, which approaches the tangent of the surface(s) 112, 112′.

This embodiment results in easier removal of the particulate contaminant via the application of the laser induced shock wave array. The process of cleaning via the laser induced shock wave array 116 in accordance with these embodiment(s) is similar to the method of cleaning a rigid substrate 14 with the exception of the curved flexible substrate(s) 114, 114′. As such, the laser assembly 120 employed in creating the laser induced shock wave array 116 in accordance with this embodiment of the present invention includes a laser beam source 122, a beam delivery assembly 124, and a control assembly 126 including a computer 136 and a motion controller 138. As with the prior embodiment, the process of generating the shock wave array 116 begins at the laser beam source 122. The laser beam source 122 creates a laser beam that is directed toward the beam delivery assembly 124.

The beam delivery assembly 124 employs a series of mirrors 130 and beam splitters 132 to split the laser beam into many lower powered laser beams 118. These lower powered laser beams 118 are then focused and directed above the exposed surface(s) 112, 112′ of the substrate(s) 114, 114′ to be cleaned at a position directly adjacent the portion of the exposed surface(s) 112, 112′ to be cleaned by the creation of the shock wave array 116.

The substrate(s) 114, 114′ is continually translated by rolling it over the roller(s) 134, 134′ in a highly controlled manner to ensure the creation of a shock wave array along the exposed surface(s) 112, 112′ in a systematic manner such that the contaminates are moved off of the exposed surface(s) 112, 112′ of the substrate(s) 114, 114′ resulting in a clean surface for subsequent use and fabrication.

In accordance with a preferred embodiment of the present invention, the roller(s) 134, 134′ are made of stainless steel although other materials could be used without departing from the spirit of the present invention. The material of the roller should be rigid enough so that a majority of the force created by the shock waves is imparted to the contaminants on the surface, rather than into the material from which the roller is composed. In the single roller embodiment shown with reference to FIG. 4 the roller 134 can roll towards the incident lower powered laser beams 118 however this is not a critical factor. The gas should always be directed towards the contaminated side of the surface 112. With the double roller version shown with reference to FIGS. 5A and 5B, it is envisioned the shock wave array 116 may be used to simultaneously clean surfaces 112, 112′ of two different substrates 114, 114′ (see FIG. 5A) or to clean opposite sides 112, 112′ of the same substrate 114 where a roller assembly is used to convey the substrate 114 about a series of rollers such that opposite sides 112, 112′ of the same substrate 114 are simultaneously exposed to the shock waves (see FIG. 5B). Whether the shock waves are exposed to two different substrates 114, 114′ or opposite sides of the same substrate 114, it is preferred that the substrate(s) 114, 114′ both move in the same direction so that gas is always blowing towards the contaminated side of the substrate 114, 114′ to prevent recontamination. The process employed through the utilization of the laser induced shock wave array 116 in accordance with this embodiment, that is, the creation of the laser beams 118 and the movement of the substrate 114, 114′, is controlled by the control assembly 126. As discussed above, it is contemplated that a system 110 employing one roller 134 or a system 110′ employing two rollers 134, 134′ may be used to support the flexible substrate 114, 114′. It is contemplated that the two roller system 110′ will be more preferable, although more expensive, since it would allow for cleaning of both sides of the flexible substrate 114, 114′ during treatment of the flexible substrate 114, 114′ along the line defined by the shock wave array 116.

Referring to FIGS. 4, 5A and 5B, a single roller system 110 and a double roller system 110′ are respectively disclosed. In accordance with the single roller system 110, the laser beam source 122 and beam delivery assembly 124 sit adjacent the apex of the single roller 134 and directs a series of laser beams 118 tangentially to the apex of the exposed surface 112 of the flexible substrate 114 as it passes over the roller 134 to create a laser induced shock wave array 116. The flexible substrate 114 is drawn about the roller 134 such that the flexible substrate 114 is continually passed across the point at which the laser induced shock wave array 116 is created.

In accordance with the two-roller system 110, a first roller 134 and a second roller 134′ are provided. The first roller 134 and the second roller 134′ are preferably oriented such that they create a mirror image of the flexible substrate(s) 114, 114′ as they pass over the respective first roller 134 and the second roller 134′. More particular, the first and second rollers 134, 134′ are oriented such that their respective longitudinal axes are parallel and lie in the same plane. In addition, and as will be appreciated based upon the following disclosure, the first and second rollers 134, 134′ are spaced sufficiently close such that a single line of laser beams 118 may be applied between the first and second rollers 134, 134′ which creates a shock wave array 116 simultaneously cleaning both the first exposed surface 112 (that is, of the flexible substrate 114 passing over the first roller 134 in either the embodiment disclosed with reference to FIG. 5A or 5B) and the second exposed surface 112′ (that is, of the flexible substrate 114′ passing over the second roller 134′ as shown in FIG. 5A or the opposite side of the first substrate 114 passing over the second roller 134′ as shown in FIG. 5B).

In accordance with a preferred embodiment, and in order to ensure the first substrate 114 and the second substrate 114′ (see FIG. 5A), or the first substrate 114 when opposite sides are cleaned as shown in FIG. 5B, are moving over the first and second rollers 134, 134′ in the same direction, the first roller 134 rotates in a counterclockwise direction while the second roller 134′ rotates in a clockwise direction.

In addition to the embodiments described, it is contemplated a carrier gas may be implemented into the present system to facilitate particulate removal on the exposed surface of the substrate and the prevention of recontamination of the surface. It is contemplated that ducting and venting may be used to direct the flow of the carrier gas entrained with the particulates away from the surface. The particulates may then be collected by various different trapping methods, such as filtration, electrostatic precipitators, cyclone, etc.

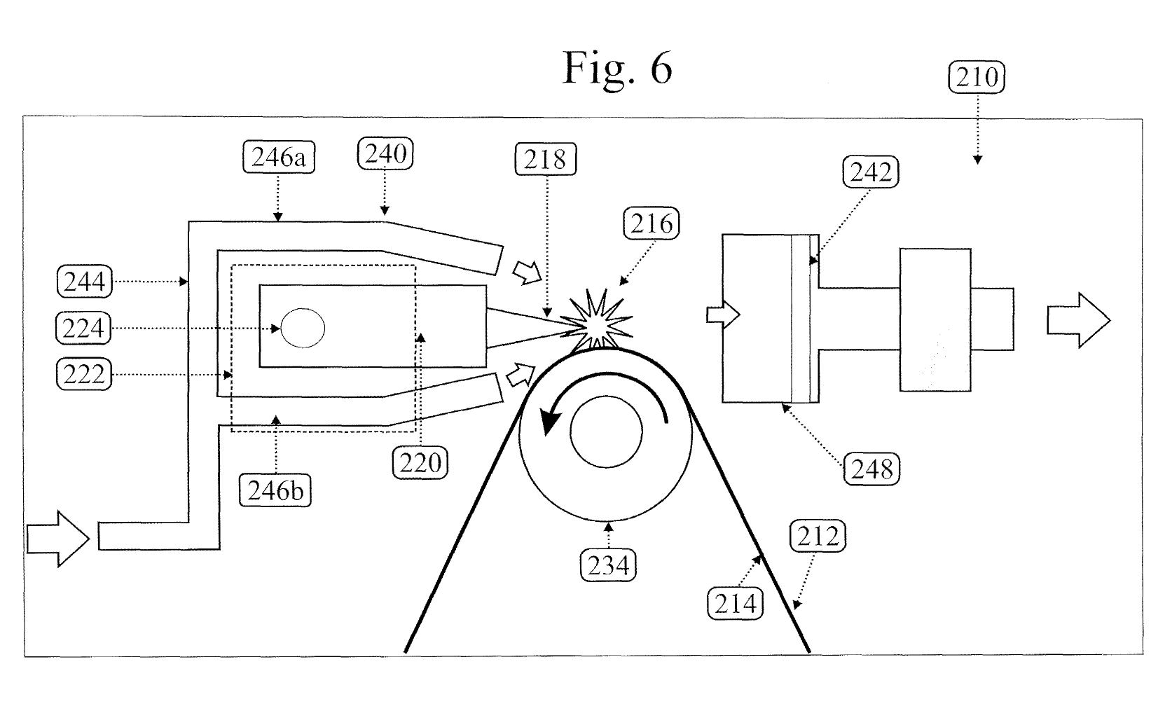

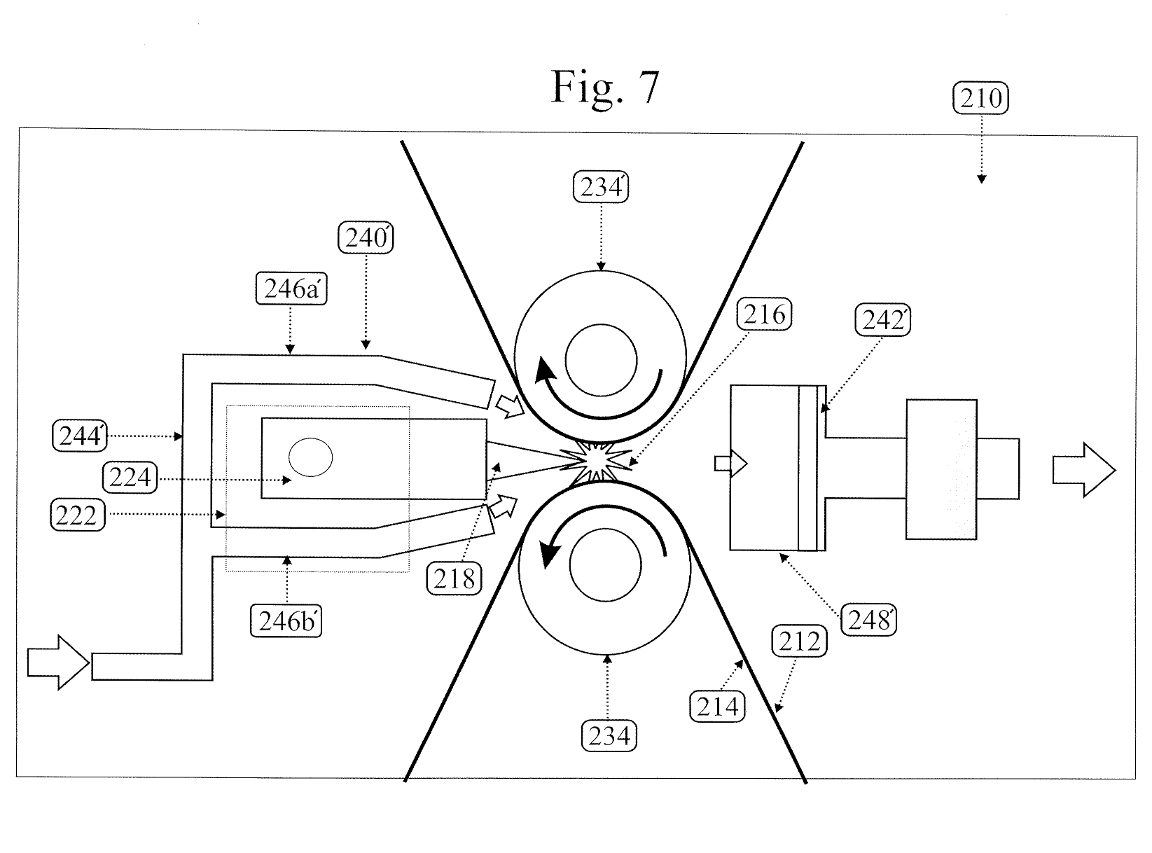

More particularly, and with reference to FIGS. 6 and 7, systems 210, 210′ with one roller 234 and two-roller 234, 234′ similar to those disclosed above with reference to FIGS. 4 and 5, are disclosed that employ a duct 240, 240′ and a vent 248, 248′ in an effort to enhance contaminant removal. As such, these systems 10, 210′ include a laser assembly 220, 220′ including a laser beam source 222, 222′ which providing a laser beam to a beam delivery system 224, 224′ for the delivery of lower powered laser beam 218, 218′ for the creation of shockwaves 216, 216′. In accordance with these embodiments, the basic construction of the one roller system 210 and two-roller system 210′ are substantially the same as respectively disclosed with reference to FIGS. 4 and 5, however, a duct 240, 240′ and vent 248, 248′ are integrated into the system 210, 210′. The duct 240, 240′ includes a gas inlet line 244, 244′ through which the carrier gas is introduced to the system 210, 210′. The gas inlet line 244, 244′ divides into first and second outlet tubes 246a, 246b, 246a′, 246b′ positioned adjacent to the laser induced shock wave array 116 such that the shock wave array 116 is exposed to carrier gas exiting the first and second outlet tubes 246a, 246b, 246a′, 246b′.

The carrier gas is directed such that it is gathered by an exit port 248, 248′ of the duct 240, 240′ for removal from the system 210, 210′. A filter 242, 242′ may be positioned within the exit port 248, 248′ for gathering contaminants which then may be removed using conventional mechanisms known to those skilled in the art.

While the preferred embodiments have been shown and described, it will be understood that there is no intent to limit the invention by such disclosure, but rather, is intended to cover all modifications and alternate constructions falling within the spirit and scope of the invention.

1. A contamination removal system for continuous cleaning of contamination from an exposed contaminated surface of a substrate by creating and moving a laser induced shock wave array across the contaminated surface, comprising:
a laser beam source;
a beam delivery assembly receiving a beam generated at the laser beam source and directing the beam for the generation of a shock wave array, the beam delivery assembly includes mirrors and beam splitters which split the laser beam into many laser beams;
a control assembly composed of an analog or digital controller); and a motion controller are linked to the operating components of the present system and ensure proper operation thereof;
a substrate motion control/holder assembly supporting the substrate adjacent the beam delivery assembly, the substrate motion control/holder assembly being linked to the motion controller of the control assembly for complete and comprehensive operation, wherein the substrate motion control/holder assembly continually translates the substrate in a highly controlled manner to ensure the creation of the shock wave array along the exposed contaminated surface of the substrate in a systematic manner such that the contaminates are moved off of the exposed contaminated surface of the substrate resulting in a clean surface for subsequent use and fabrication.

2. The contamination removal system according to claim 1, wherein the laser beams are oriented in a line running transverse to the direction of relative movement between the line of laser beams and the substrate.

3. The contamination removal system according to claim 1, wherein the laser beam source is a Nd:YAG laser producing laser light with a pulse width in the nanosecond to subnanosecond range.

4. The contamination removal system according to claim 1, wherein the substrate motion control/holder assembly is a translational stage used to move the substrate past the shock wave array.

5. The contamination removal system according to claim 1, wherein the substrate motion control/holder assembly is a rotational stage.

6. The contamination removal system according to claim 5, wherein the rotational stage includes at least one roller allowing the substrate to pass thereover.

7. The contamination removal system according to claim 6, wherein the laser beam source and beam delivery assembly sit adjacent an apex of the single roller and directs the laser beams tangentially to the apex of the exposed surface of the flexible substrate as it passes over the single roller to create a laser induced shock wave array.

8. The contamination removal system according to claim 5, wherein the at least one roller is made of stainless steel.

9. The contamination removal system according to claim 5, wherein the rotational stage includes a first roller and a second roller.

10. The contamination removal system according to claim 9, wherein the first roller and the second roller are oriented such that their respective longitudinal axes are parallel and lie in the same plane.

11. The contamination removal system according to claim 10, wherein the first roller and the second roller are spaced sufficiently close such that a single line of lower powered laser beams may be applied between the first roller and the second roller creating a shock wave array simultaneously cleaning both a first exposed contaminated surface of the flexible substrate passing over the first roller, and a second exposed contaminated surface of the flexible substrate passing over the second roller.

12. The contamination removal system according to claim 1, wherein the laser beam source creates a laser beam that is directed toward the beam delivery assembly.

13. The contamination removal system according to claim 1, wherein the lower powered laser beams are oriented in a line running transverse to a direction of relative movement between the line of the laser beams and the substrate.

14. The contamination removal system according to claim 1, wherein the laser beams are focused and directed tangentially above the exposed contaminated surface of the substrate to be cleaned, creating a shock wave array positioned directly above that portion of the exposed contaminated surface cleaned by the creation of the shock wave array.

15. The contamination removal system according to claim 1, further including a carrier gas to facilitate particulate removal on the exposed contaminated surface of the substrate and the prevention of recontamination of the exposed contaminated surface.
